(19) United States
(12) Patent Application Publication
(10) Pub. No.: US 2010/0079049 A1
(43) Pub. Date: Apr. 1, 2010

(54) PLASMA DISPLAY DEVICE

(75) Inventors: Hidenao Kubota, Yokohama (JP); Kazuhiro Kaizaki, Yokohama (JP); Daisuke Honda, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/425,010

(22) Filed: Apr. 16, 2009

(30) Foreign Application Priority Data
Sep. 30, 2008 (JP) 2008-253644

(51) Int. Cl. H01J 61/40

(52) U.S. Cl. 313/112

(57) ABSTRACT

A plasma display device refines contrast, suppresses moiré, and maintains mechanical strength against shocks from the outside of the device. A front panel is disposed at a distance D from the front of the plasma display panel. A contrast refine film in which light absorption parts and light transmission parts extending in the same direction as scanning electrodes, discharge sustaining electrodes, and the like, which are formed on the plasma display panel, are formed with a certain pitch is stuck to the front substrate of the plasma display panel. This helps to refine contrast and suppress moiré below a proper level. An antireflection film, a color tone film, an electromagnetic radiation preventing film, a near-infrared absorption film, and the like are all disposed in the front panel. This helps to prevent deterioration of each optical film during operation.

### CLAIM OF PRIORITY

The present application claims priority from Japanese Patent Application JP 2008-253644 filed on Sep. 30, 2008, the content of which is hereby incorporated by reference into this application.

### BACKGROUND OF THE INVENTION

1. Field of the Invention

The present invention relates to a display device, and more particularly to a plasma display device with contrast refined.

2. Description of the Related Art

There is an increasing demand for a plasma display device using a plasma display panel (PDP) because it is thin and capable of displaying a large screen. The plasma display device includes a plasma display panel, a front panel disposed in the front of the plasma display panel, a driving circuit at the back of the plasma display panel, and a frame housing them.

The front panel generally has layers of an antireflection film, a film for preventing the emission of electromagnetic waves, and a color filter for adjusting the color tone of images. The substrates are made of glass or resin such as PET. The plasma display panel is constructed with a front substrate and a rear substrate overlapping each other wherein scanning electrodes and discharge sustaining electrodes are formed in the front substrate, and address electrodes and the like are formed in the rear substrate.

Since the front panel has an important influence on the image quality, manufacturing costs, and the like of the plasma display device, various technologies are proposed. JP-A No. 84677/2003 discloses a construction in which only a minimum of functions is provided for the front panel, for example, by using only a glass plate as a role as protection against shocks from the outside, or forming only a film for preventing the emission of electromagnetic waves, thereby reducing costs of the front panel.

JP-A No. 30844/2006 discloses a construction in which the contrast of images is refined by disposing an island-shaped visible light absorption pattern in a matrix form on the part of the plasma display panel of the front panel. At the same time, it discloses a construction in which contrast and brightness are refined by providing a reflection layer at the back of the island-shaped visible light absorption pattern, that is, on the part of the plasma display panel to reflect light incident on the island-shaped visible light absorption pattern from the plasma display panel and take out the light to the outside after multiple reflection.

JP-A No. 122737/2008 discloses a construction in which contrast is refined by sticking an antireflection film, an electromagnetic wave shield film, an infrared cut film, or the like to a PET film serving as a base material of the front panel by an adhesive material wherein a flake-like black light absorber is dispersed in the adhesive material, square to the face of the adhesive material.

JP-A No. 96686/2008 discloses a construction in which a so-called black stripe film is stuck to the front panel to prevent the reflection of external light and refine contrast wherein black light absorption parts extending horizontally when viewed from an observation side of images by alternately disposing light absorption parts and light transmission parts are formed in a stripe shape. Also, JP-A No. 96686/2008 describes that the black stripe film may be stuck to the plasma display panel.

FIG. 15 is an exploded perspective view of a plasma display device. In FIG. 15, a front panel 40 is disposed at a distance of 5 mm to 10 mm from the front surface of a plasma display panel 100. At the back of the plasma display panel, a chassis 200 mounting a driving circuit and the like, a driving circuit 300, and the like are disposed, and covered by a back cover 400.

The plasma display device is superior in contrast of the display device itself to liquid crystal devices and the like, but has a problem with reduction in contrast due to the reflection of external light. As a technology for preventing the reduction in contrast, it is well known that the above-described black stripe film is disposed in the front panel. Thereinafter, the black stripe film will be referred to as CRF (Contrast Refine Film or Contrast Rising Film) as a film for refining contrast. Since the CRF cuts off light from a vertical, oblique, and forward direction of a display device, it is effective in refining contrast, particularly when display devices are on display in a shop.

FIG. 16 shows an example that disposes CRF, an antireflection film, a color tone film, an electromagnetic radiation preventing film, a near-infrared absorption film (thereinafter referred to as an NIR film), and the like in the front panel 40 without forming the optical films in the plasma display panel. The CRF has light absorption parts and light transmission parts disposed alternately. On the other hand, in the front substrate 1 of the plasma display panel 100, bus electrodes are cyclically disposed in a horizontal direction of the screen. In this case, moiré occurs between the front panel 10 and the plasma display panel 100.

FIG. 17 shows an example that disposes all optical films 500 such as CRF, an antireflection film, a color tone film, an electromagnetic radiation preventing film, a near-infrared absorption film (thereinafter referred to as an NIR film), and the like in the plasma display panel 100 without using the front panel 40. The construction as shown in FIG. 17 has a problem that the color tone film susceptible to temperatures changes in nature because of heat generated in the plasma display panel 100. A more serious problem is that the plasma display device is easily destroyed by mechanical shocks from the outside because of the lack of the front panel 40.

### SUMMARY OF THE INVENTION

An object of the present invention is to refine contrast by using CRF, reduce moiré, and maintain strength against mechanical shocks from the outside of a plasma display device.

The present invention solves the problems as described above, and describes concrete means below.

(1) A plasma display device includes a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction, and a front panel disposed at a specific distance from the front substrate of the plasma display panel. On the front substrate of the plasma display panel, a black stripe film (CRF) having light absorption parts that extend in the first direction and are arrayed in the second direction is disposed, and on the front panel, an antireflection film, a color tone adjustment film, an electromagnetic radiation preventing film, and a near-infrared radiation preventing film are formed.

(2) The plasma display device described in (1) is characterized in that the light absorption parts of the black stripe film are larger in width on the part of the front substrate and smaller in width on the part of the front panel.

(3) A plasma display device includes a plasma display panel having a front substrate on which scanning electrodes extend in a first direction, and are arrayed in a second direction, discharge sustaining electrodes extend in the first direction, and are arrayed in the second direction, and the scanning electrodes and the discharge sustaining electrodes are arrayed in the second direction at an equal distance W, and a rear substrate on which address electrodes extend in the second direction, and are arrayed in the first direction, and a front panel disposed at a specific distance from the front substrate of the plasma display panel. On the front substrate of the plasma display panel, a contrast refine film having light absorption parts that extend in the first direction and are arrayed in the second direction with a pitch P is disposed, wherein a relation of W/P=N (N is an integer) exists between the distance W between the scanning electrodes and the discharge electrodes, and the pitch P of the light absorption parts of the black stripe film, and on the front panel, an antireflection film, a color tone adjustment film, an electromagnetic radiation preventing film, and a near-infrared radiation preventing film are formed.

(4) The plasma display device described in (3) is characterized in that the light absorption parts of the black stripe film are larger in width on the part of the front substrate and smaller in width on the part of the front panel.

(5) The plasma display device described in (3) is characterized in that the light absorption parts of the black stripe film are formed in positions corresponding to the scanning electrodes and the discharge sustaining electrodes formed on the front substrate.

(6) The plasma display device described in (3) is characterized in that the N is 1.

(7) A plasma display device includes a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction, and a front panel disposed at a specific distance from the front substrate of the plasma display panel. On the front substrate of the plasma display panel, a black stripe film having light absorption parts that extend in the first direction and are arrayed in the second direction is disposed, an the light absorption parts have conductivity, and are electrically conducted with each other, and on the front panel, an antireflection film, a color tone adjustment film, and a near-infrared radiation preventing film are formed.

(8) A plasma display device includes a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction, and a front panel disposed at a specific distance from the front substrate of the plasma display panel. On the front substrate of the plasma display panel, a black stripe film having light absorption parts that extend in the first direction and are arrayed in the second direction, and an electromagnetic radiation preventing film are disposed, and on the front panel, an antireflection film, a color tone adjustment film, and a near-infrared radiation preventing film are formed.

By disposing a contrast refine film on the front substrate of a plasma display panel, the contrast of images can be refined and the degree of moiré can be reduced. Moreover, by disposing other optical film layers on the front panel distant from the plasma display panel, the optical films can be prevented from being changed in nature due to heat generated in the plasma display panel, and reliability can be increased.

### BRIEF DESCRIPTION OF THE DRAWINGS

FIG. 1 is a sectional perspective view of a display area of a plasma display panel;

FIG. 2 is a plan view of the plasma display panel;

FIG. 3 is a plan view of a pixel part of the plasma display panel;

FIG. 4 is a sectional schematic view showing the disposition of CRF in the present invention;

FIG. 5 is a perspective view of CRF;

FIG. 6 is a sectional view of the plasma display panel of a first embodiment;

FIG. 7 is a schematic view showing the relationship between the plasma display panel and external light;

FIG. 8 is a graph showing the effects of CRF;

FIG. 9 is an example of a front panel used in the present invention;

FIG. 10 is another example of the front panel used in the present invention;

FIG. 11 is a plan view showing the structure of a mesh;

FIG. 12 is a sectional view of the plasma display panel of a second embodiment;

FIG. 13 is a sectional view of the plasma display panel of a third embodiment;

FIG. 14 is a plan schematic view of CRF of a third embodiment;

FIG. 15 is an exploded perspective view of a plasma display device;

FIG. 16 is a disposition example of the plasma display and the front panel; and

FIG. 17 is an example of forming an optical film layer in the plasma display panel.

### DETAILED DESCRIPTION OF THE PREFERRED EMBODIMENTS

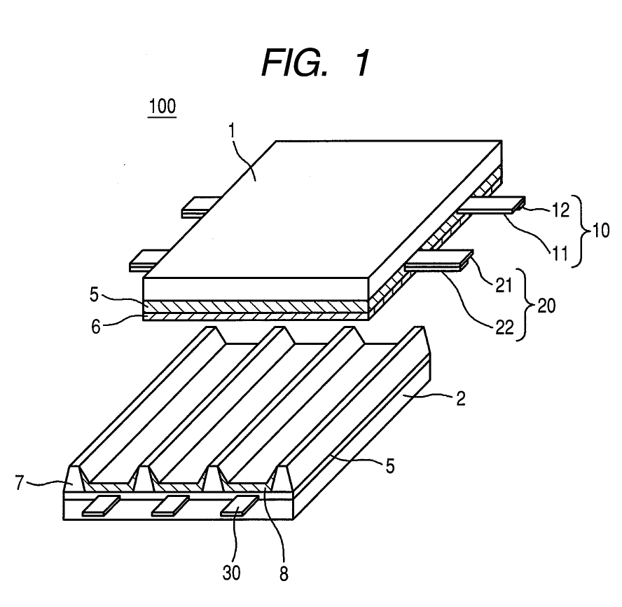

Before describing concrete embodiments of the present invention, a description will be made of the structure of a plasma display panel 100 to which the present invention is applied. FIG. 1 is an exploded sectional perspective view of a display area of the plasma display panel 100. The plasma display panel 100 includes the two glass substrates of a front substrate 1 and a rear substrate 2. On the front substrate 1, a scanning electrode 20 and a discharge sustaining electrode 10 for causing discharge to form images are disposed in parallel.

The scanning electrode 20 further includes a scanning discharge electrode 21 formed by ITO (Indium Tin Oxide) that actually serves as a discharge electrode, and a scanning bus electrode 22 that supplies voltage from a terminal part. The scanning electrode 20 is also referred to as a Y electrode. The scanning bus electrode 22 is also referred to as a Y bus electrode.

The discharge sustaining electrode 10 further includes a discharge sustaining discharge electrode 11 formed by ITO (Indium Tin Oxide) that actually serves as a discharge electrode, and a discharge sustaining bus electrode 12 that supplies voltage from a terminal part. The discharge sustaining electrode 10 is also referred to as an X electrode. The discharge sustaining bus electrode 12 is also referred to as an X bus electrode.

Both the X bus electrode 12 and the Y bus electrode 22 have a laminated structure of metal, and have a laminated structure of chrome, copper, and chrome in the direction that departs from the front substrate 1. Since the chrome formed on the front substrate 1 has excellent adhesiveness to glass and the surface of the chrome is black, it has the effect of further refining contrast. The copper is used to reduce the resistance of the bus electrode. The copper is further covered with the chrome, which helps to prevent resistance from changing as a result of oxidation of the copper surface.

The chrome on the front glass may have a laminated structure of chrome oxide and chrome. Since the chrome oxide is black and has a reflection factor smaller than chrome, the contrast of images can be further refined. Chrome oxide also has an excellent adhesiveness to glass. Moreover, since the contact face with the copper is chrome, the copper is never oxidized.

In FIG. 1, the discharge electrode uses the transparent conductive film ITO, and the bus electrode uses a metal laminated film that is small in resistance. This is because use of the transparent conductive film enables more light to be emitted from phosphors 8 to the outside. On the other hand, the discharge electrode may be formed by the same metal as the bus electrode. In this case, the number of processes is one, contributing to significant reduction in manufacturing costs.

A dielectric layer 5 is formed to cover the X electrode and Y electrode. For the dielectric layer 5, low melting-point glass having a softening point of about 500° C. is used. On top of it is formed a protection film 6. Magnesium oxide (MgO) is primarily used as the protection film 6, which is formed by the sputtering method or vapor deposition method.

On the rear substrate 2, address electrodes 30 are formed orthogonally to the scanning electrode 20 or discharge sustaining electrode 10. The structure of the address electrodes 30, which is the same as the scanning electrode 20 or discharge sustaining electrode 10, is a laminated structure of chrome, copper, and chrome. The dielectric layer is covered over the address electrodes 30. Generally, the dielectric layer 5 formed in the rear substrate 2 is also made of the same material as the dielectric layer 5 formed in the front substrate 1.

Barrier plates 7 are formed over the dielectric layer 5 of the rear substrate 2 to extend in the same direction as the address electrodes 30 so as to sandwich the address electrodes 30. The phosphors 8 are coated inside the barrier plates 7. The phosphors 8 red, green, and blue are coated in parallel in depressions formed by the barrier plates 7 of FIG. 1.

A space surrounded by the front substrate 1, rear substrate 2, and barrier plates 7 is a discharge space in which discharge gas is sealed. A portion between a pair of bus wirings and the barrier plates 7 corresponds to one display cell (sub-pixel), and in the case of color display, three sub-pixels correspond to the primary colors (R, B, G), respectively, and form one pixel.

The principle of light emission of the plasma display 100 is described below. First, a voltage of about 100 to 200V (discharge start voltage) is applied between an address electrode 30 corresponding to a cell intended to emit light, and a scanning electrode 20 corresponding to the cell. Since the address electrode 30 and a bus electrode are orthogonal to each other, a single cell at their intersection can be selected. In the selected cell, a weak discharge occurs between a discharge electrode (Y electrode in this case) to which the voltage is applied, and the address electrode 30, and electric charges (wall charges) are stored on the protection film 6 over the dielectric layer 5 of the front substrate 1. In this way, writing by electric charges is made to all cells of the display area. The period is a writing period during which no image is formed.

Next, during a sustain period, high-frequency pulses are applied between the X electrode and Y electrode to carry out sustaining discharge. At this time, the sustaining discharge occurs only in the cell in which wall electrodes are stored. The sustaining discharge generates ultraviolet rays, which cause the phosphors 8 to emit light. Visible light emitted from the phosphors 8 is emitted from the front substrate 1 and viewed by human. Since the phosphors 8 emit light only in the cell in which electric charges are stored during the writing period, an image is formed.

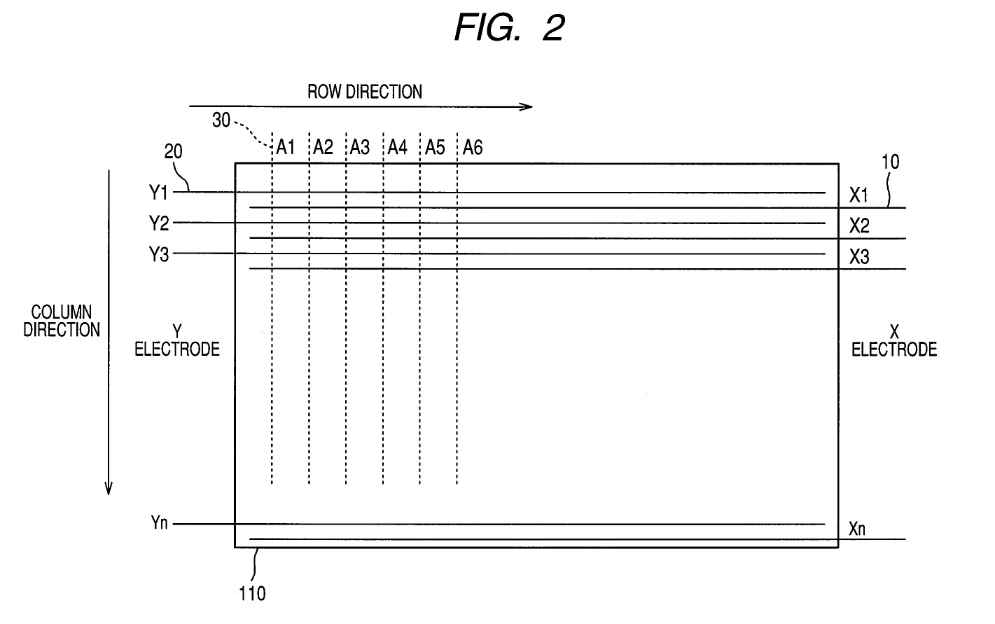

FIG. 2 is a plan view showing the electrode disposition of the plasma display panel. In FIG. 2, within a display area 110, Y electrodes serving as scanning electrodes 20 extend laterally, and are arrayed longitudinally at a certain pitch. X electrodes serving as discharge sustaining electrodes 10 extend laterally, and are arrayed longitudinally at a certain pitch. Terminals for the Y electrodes are at the left of the display area 110, and terminals for the X electrodes are disposed at the right of the display area 110. The X and Y electrodes are formed on the front substrate 1.

In FIG. 2, electrodes serving as the address electrodes 30 extend in the longitudinal direction of the display area 110, and are arrayed laterally at a certain pitch. The address electrodes 30 are formed in the rear substrate 2. Terminals for the address electrodes 30 are often formed in the vertical direction of the display area 110. This is because the pitch of the address electrodes 30 is much smaller than the pitches of the scanning electrodes 20 or the discharge sustaining electrodes 10. The intersection of a pair of a scanning electrode 20 and a discharge sustaining electrode 10 that are formed in the front substrate 1, and an address electrode 30 forms one sub-pixel.

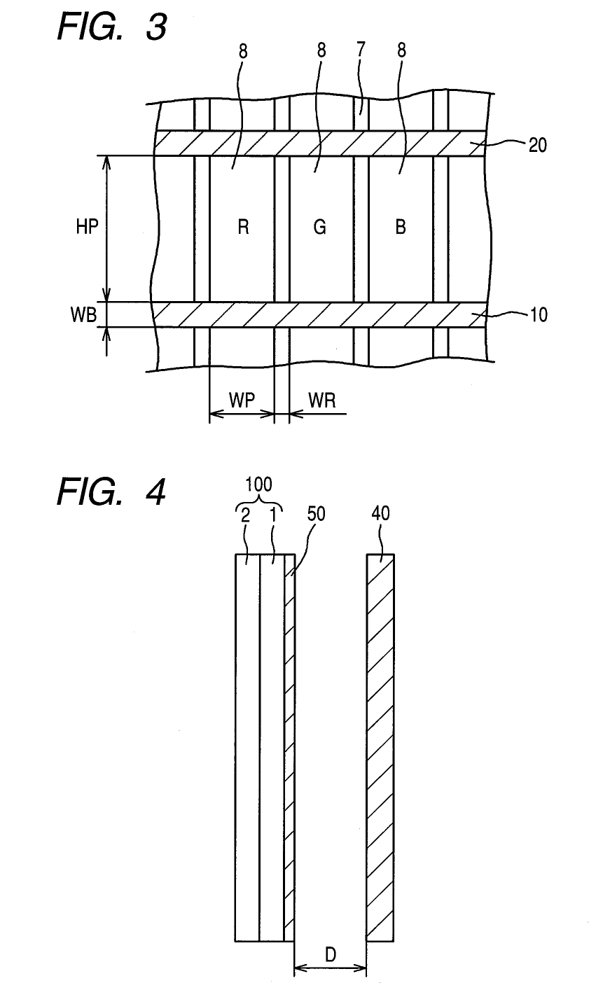

FIG. 3 is a plan view showing the pixel structure of the display area 110. A portion surrounded by a Y electrode serving as a scanning electrode 20, an X electrode serving as a discharge sustaining electrode 10, and the barrier plates 7 formed in the rear substrate 2 is one sub-pixel. Although the cross section of the barrier plates 7 is trapezoid as shown in FIG. 1, only the upper portion of the barrier plates 7 is shown in FIG. 3. In each sub-pixel, a different phosphor 8 is formed for each of red, green, and blue. One pixel is formed by a red sub-pixel, green sub-pixel, and blue sub-pixel.

In FIG. 3, the vertical diameter HP of a sub-pixel is, for example, 650 μm, and the horizontal diameter WP is, for example, 130 μm. The width of the scanning electrodes 20 and the discharge sustaining electrodes 10 is 240 μm, and the width of the barrier plates 7 is 60 μm. Therefore, the pitch of sub-pixels is 780 μm vertically, and 300 μm horizontally. Since one pixel is 780 μm vertically and 300 μm horizontally, it has a laterally long shape.

### First Embodiment

FIG. 4 is a schematic diagram showing a first embodiment of the present invention. FIG. 4 shows only the plasma display panel 100 and the front panel 40 taken out of the plasma display device of the present invention. In FIG. 4, a contrast refine film (CRF) 50 as a black stripe film is stuck to the plasma display panel 100. As described above, in the CRF 50, horizontally extending light transmission parts for vertically transmitting light from the plasma display panel 100, and horizontally extending black light absorption layers for absorbing light from the outside (external light) are alternately arrayed. When viewed from an image observation side, the horizontally extending black light absorption layers are formed in a stripe shape. The front panel 40 is disposed at a distance of D from the plasma display panel 100. The distance D between the plasma display panel 100 and the front panel 40 is 5 to 10 mm.

A characteristic of the present embodiment shown in FIG. 4 is that only the CRF 50 is disposed in the plasma display panel 100, and other optical films are all disposed in the front panel 40. In the present embodiment, since the front panel 40 is used, strength is maintained against mechanical shocks on the plasma display device. For example, while shock weight strength is 1 J when the front panel 40 does not exist, it is 7 J when the front panel 40 exists.

In the present embodiment, all optical films except the CRF 50 are disposed in the front panel 40. The optical films include, for example, a color tone film that is sensitive to heat. Although the plasma display panel 100 becomes hot during operation, since the optical films are formed in the front panel 40 distant from the plasma display panel 100, deterioration due to heat can be prevented.

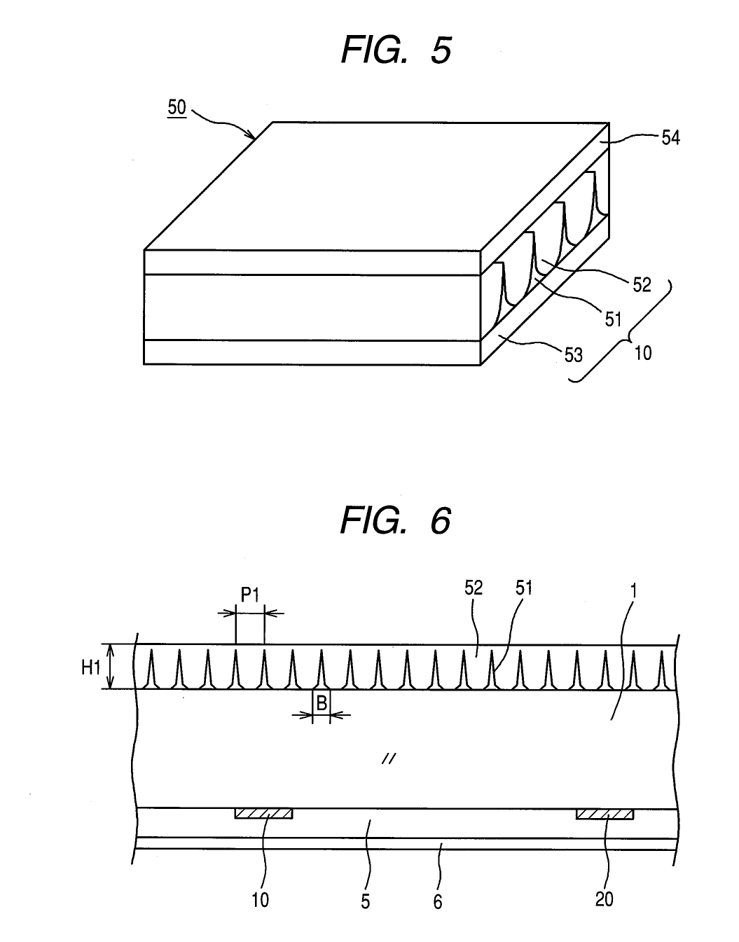

FIG. 5 is a perspective view of the CRF 50 stuck to the plasma display 100. The CRF 50 has light absorption parts 51 and light transmission parts 52 alternately formed between an emission-side substrate 54 and an incident-side substrate 53. The light absorption parts 51 are wider in width toward the incident-side substrate 53, and smaller in width toward the emission-side substrate 54. The cross section of the light absorption parts 51 has a complex shape to reduce the strength of moiré when it occurs. The cross section of the light absorption parts 51 may also have a simple wedge-like shape.

The CRF 50 is formed as described below. That is, the emission-side substrate 54 is coated with an ultraviolet hardening resin to form the light transmission parts 52. Notches corresponding to the cross sections of the light absorption parts 51 are formed by a roller for the light transmission parts 52. Then, the notches are hardened by being irradiated with ultraviolet rays to determine the shape of the notch parts, and the light absorption parts 51 are formed in the notch parts by a black pigment or the like. After that, the incident-side substrate 53 is stuck to protect the light absorption parts 51 and the like.

FIG. 6 is a sectional view showing the state in which the CRF 50 is stuck to the plasma display panel 100 in the present embodiment. FIG. 6 shows only the front substrate 1 of the plasma display panel 100, and shows the state in which the CRF 50 is stuck directly to the front substrate 1. In the CRF 50 of FIG. 6, the incident-side substrate 53 and the emission-side substrate 54 are omitted.

In FIG. 6, the light absorption parts 51 of the CRF 50 are 65 μm in pitch P1 and 120 μm in height H1. The width B of the bottom parts of the light absorption parts 51 is 21 μm. The width of the bottom parts of the light absorption parts 51 is larger than the width of the light transmission parts 52 but their bottom parts are small in thickness. Therefore, since light passes somewhat through portions small in thickness, the brightness of the plasma display panel 100 never decreases significantly.

In FIG. 6, the scanning electrode 20 and the discharge sustaining electrode 10 are shown inside the front substrate 1. The dielectric layer 5 is formed to cover the scanning electrode 20 and the discharge sustaining electrode 10, and the protection film 6 is formed to cover the dielectric layer 5. The scanning electrodes 20 and the discharge sustaining electrodes 10 are disposed at equal spaces apart mutually. As shown in FIG. 3, the pitch of the scanning electrodes 20 and the discharge sustaining electrodes 10 is 780 μm, and 12 times the pitch of the light absorption parts 51 of the CRT 50. The width of the scanning electrodes 20 and the discharge sustaining electrodes 10 is 130 μm, and twice the pitch of the light absorption parts 51 of the CRT 50.

In this case, moiré occurs that looks as if the light and shade by the CRF 50 and the light and shade by the scanning electrodes 20 and the discharge sustaining electrodes 10 overlap with each other. However, since the beat cycle of the moiré in this case is equal to the pitch of the scanning electrodes 20 and the discharge sustaining electrodes 10, it is equal to the pitch of normal light and shade when the CRF 50 does not exist, moiré is little conspicuous even if it occurs.

In this case, however, the CRF 50 must be correctly stuck to the front substrate 1 after correct control of the width and pitch of the scanning electrodes 20 and the discharge sustaining electrodes 10 formed in the front substrate 1 of the plasma display panel 100, and the pitch of the light absorption parts 51 formed in the CRF 50.

The foregoing description assumes that the scanning electrode 20 and the discharge sustaining electrode 10 are disposed at equal spaces apart mutually. For example, in FIG. 2, the space between a scanning electrode Y1 and a discharge sustaining electrode X1, the space between the discharge sustaining electrode X1 and a scanning electrode Y2, and the space between the scanning electrode Y2 and a discharge sustaining electrode X2 each are equal.

By thus correctly controlling the CRF 50 and the width and pitch of the scanning electrode 20 and the discharge sustaining electrode 10 formed in the front substrate 1 of the plasma display panel 100, moiré occurring when the CRF 50 is used can be suppressed. Such a control is enabled because the CRF 50 is stuck directly to the plasma display panel 100.

On the other hand, when the CRF 50 is formed in the front panel 40, an alignment error between the plasma display panel 100 and the CRF 50 must be taken into consideration. An alignment error between the plasma display panel 100 and the CRF 50 is about hundreds microns. In this case, even by correct control of the pitch of the light absorption parts 51 formed in the CRF 50 and the width and pitch of the scanning electrodes 20 and the discharge sustaining electrodes 10 formed in the front substrate 1 of the plasma display panel 100, it is difficult to always keep the strength of moiré within a certain range.

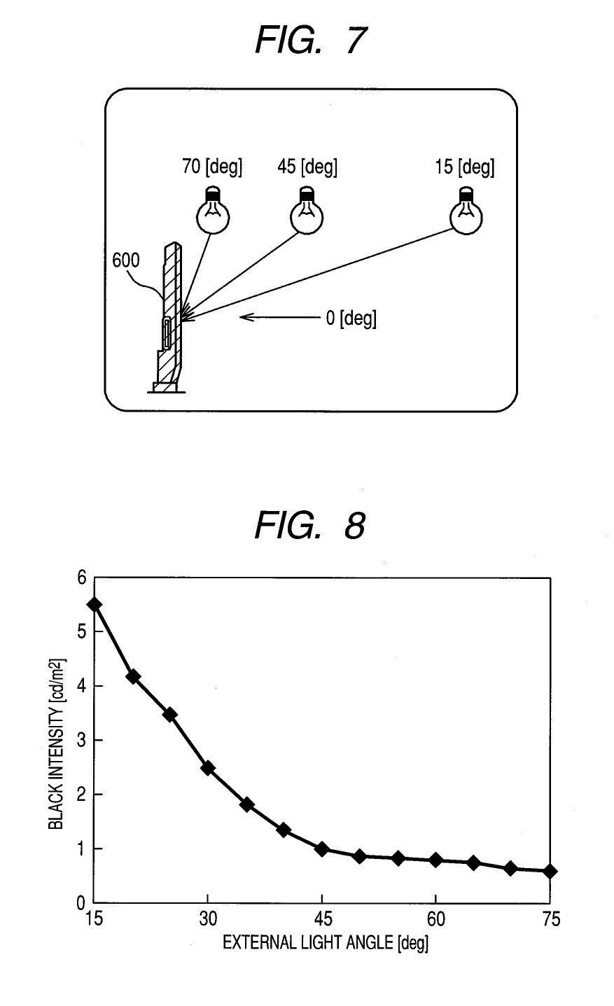

FIG. 7 shows the case where light from ceilings is incident on a plasma display device 600 in an electric appliance shop. Such a disposition is very common in shops of electric appliances. In this case, generally, contrast deteriorates because black floats due to reflection of light from the ceilings. The terms “black floats” mean that black intensity of the screen increases. A reduction in black intensity of screen would prevent deterioration of contrast.

FIG. 8 is a graph showing the state in which black intensity can be reduced when the CRF 50 shown in FIG. 6 and the like is used. In FIG. 8, the horizontal axis shows the angles of a light source with respect to the normal direction of the plasma display panel 100, as shown in FIG. 7. The vertical axis in FIG. 8 shows black intensity. FIG. 8 shows how black intensity changes when the direction of a light source is made to change from 15 degrees to 75 degrees.

It will be found from FIG. 8 that if an external light angle is greater, black intensity is restrained to be smaller, so that deterioration of contrast is prevented. That is, since the light absorption parts 51 of the CRF 50 are formed in a shape of eaves, if an external light angle is higher, a smaller amount of external light is incident directly on the screen of the plasma display panel 100.

When a plasma display is viewed in shops and general households, since a light source exists in ceilings, it can be said that there is substantially highly great effect on contrast improvement of the CRF 50. Although FIG. 8 is true of the case where the light absorption parts 51 have the cross section as shown in FIG. 6, the same is also true of the case where the light absorption parts 51 have a simple shape of eaves.

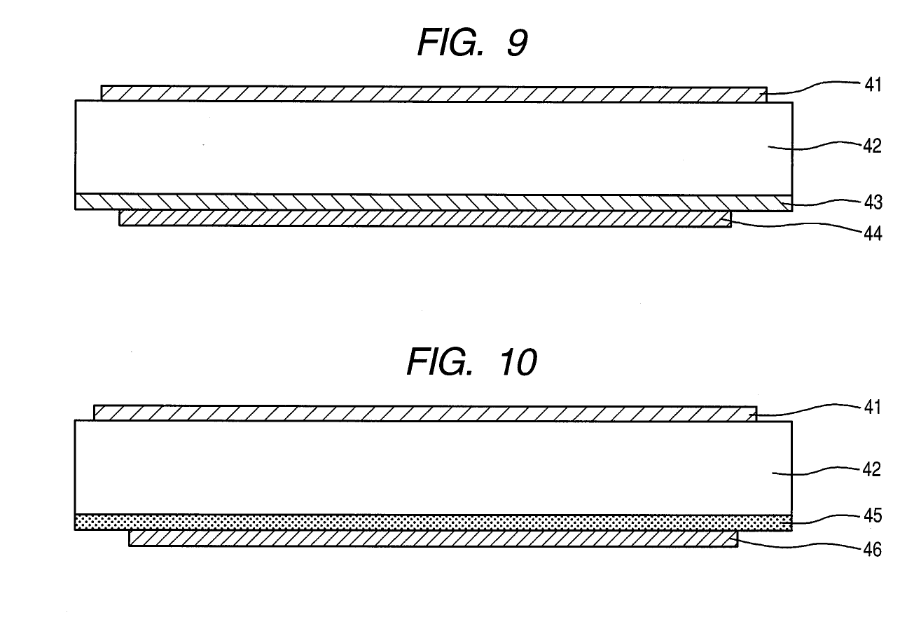

As described above, in the present embodiment, only the CRF 50 is disposed only in the plasma display panel 100, and other optical films are disposed in the front panel 40. FIG. 9 shows an example of optical films formed in the front panel 40 in the present embodiment. An antireflection film 41 serving as a color tone film as well is stuck to a filter glass 42 at the side opposite to the plasma display panel 100.

In the plasma display panel 100, a gas in which Xe of, e.g., about 8% with respect to Ne is mixed is encapsulated inside, ultraviolet rays are emitted by discharging the gas, and the phosphors 8 are lighted by the ultraviolet rays to form an image. However, discharged Ne causes light of orange color to be emitted, and it is mixed into light from the phosphors 8 and emitted to the outside. Since the light of orange color due to the discharging of Ne deteriorates image quality, it must be cut. The color tone film primarily has this function. Such a color tone film is formed by mixing pigments into organic resin. The color tone film may change in nature as a result of applying heat. To prevent it, in the present invention, the color tone film is disposed not in the plasma display panel 100 but in the front panel 40.

In a display, the reflection of external light causes images to become hard to view. Therefore, an antireflection film is formed in the surface of the screen. The antireflection film can be formed in various ways. For example, an antireflection effect can be obtained by making the surface rough. However, the most effective method is to alternately stack a material with a high refractive index and a material with a low refractive index. Also, when a base material has a high refractive index, an antireflection effect can be obtained by coating the base material with a material having a refractive index lower than that of the base material. In this embodiment, as an antireflection film, a color tone film is used that has a structure in which a material with a high refractive index and a material with a low refractive index are stacked.

In FIG. 9, on the part of the plasma display 100 of the filter glass 42, a silver thin film 43 is formed by sputtering to prevent high frequencies generated in the plasma display panel 100 from being emitted to the outside. In the plasma display panel 100, to sustain discharge, a high-frequency voltage is applied between the scanning electrode 20 and the discharge sustaining electrode 10. As a result, high-frequency electromagnetic waves are generated, and cause various problems when emitted to the outside. On the other hand, grounding the silver thin film 43 prevents electromagnetic waves generated in the plasma display panel 100 from being emitted to the outside.

In FIG. 9, since the silver thin film 43 is mechanically sensitive because of a thin film, it is covered with a protection film 44. The protection film 44 is, in some cases, provided with the function of cutting near-infrared rays generated within the plasma display 100.

FIG. 10 shows another example of optical films formed in the front panel 40 in the present embodiment. FIG. 10 is the same as FIG. 9 in that the antireflection film 41 serving as a color tone film as well is stuck to the filter glass 42 at the side opposite to the plasma display panel 100.

In FIG. 10, a mesh film 45 is disposed in the filter glass 42 on the part of the plasma display panel 100. A mesh 451 is the same as the silver thin film 43 in FIG. 9 in that it prevents electromagnetic waves from being emitted from the plasma display device to the outside. Since the mesh 451 is made of copper, expensive silver need not be used.

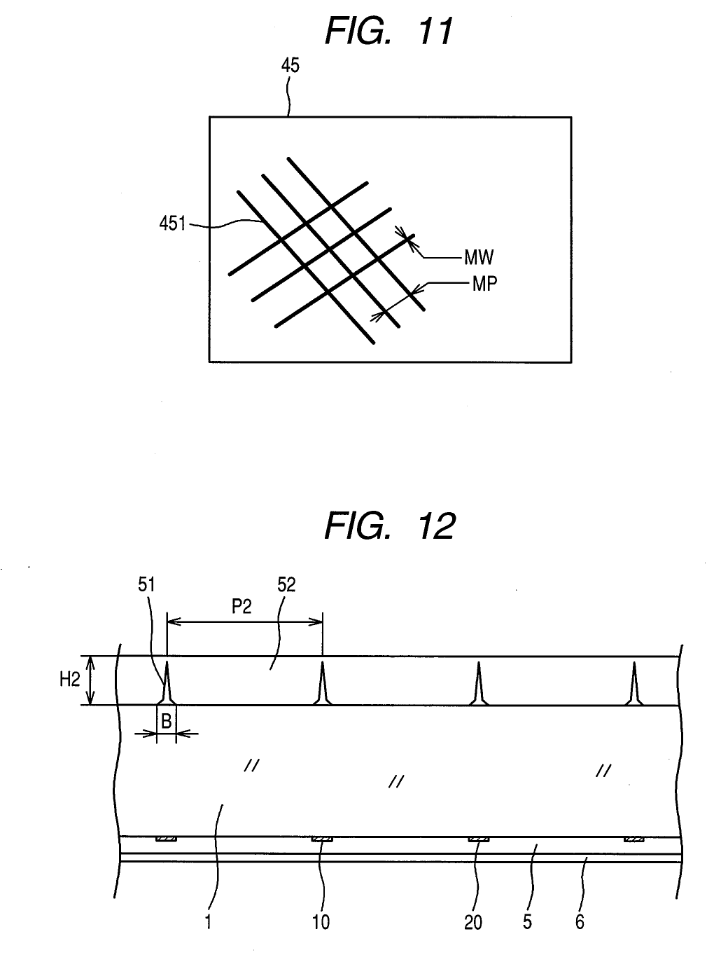

FIG. 11 is a schematic view showing the shape of the mesh 451. The mesh 451, made of copper, extends in the direction of 45 degrees with respect to the screen of the plasma display panel 100. Thus inclining the angle of the mesh 451 prevents moiré due to interference with the scanning electrodes 20, the discharge sustaining electrodes 10, the address electrodes 30, and the like in the plasma display panel 100. In FIG. 11, the pitch MP of the mesh 451 is, e.g., 300 μm, and the line width MW of the mesh 451 is, e.g., 10 μm. This degree of the mesh 451 width would disable viewing from the outside.

In FIG. 10, an NIR film 46 (near-infrared preventing film) is stacked on the mesh film 45. The inside of the plasma display panel 100 becomes hot, and near-infrared rays are generated. On the other hand, the near-infrared rays are used for control by a remote control of the plasma display device. Since the emission of near-infrared rays from the plasma display panel 100 causes a malfunction in equipment using near-infrared rays, the near-infrared rays are cut by the NIR film 46.

As described above, according to the present embodiment, since only the CRF 50 is disposed in the plasma display panel 100, and other optical films or optical functions are disposed in the front panel 40, contrast can be kept high, and moiré can be suppressed. Furthermore, deterioration of optical films and the like can be prevented, and strength can be maintained against mechanical shocks on the plasma display device.

### Second Embodiment

FIG. 12 is a sectional view showing a second embodiment of the present invention. FIG. 12 is a sectional view showing the state in which the CRF 50 is stuck to the front substrate 1 of the plasma display panel 100. In FIG. 12, the emission-side substrate 54 and the incident-side substrate 53 of the CRF 50 are omitted. The present embodiment is greatly different from the first embodiment in that the pitch of the light absorption parts 51 of the CRF 50 is much greater than that in the first embodiment, and is equal to the pitch between the scanning electrode 20 and the discharge sustaining electrode 10 formed in the front substrate 1 of the plasma display panel 100.

A characteristic of the present embodiment is that moiré does not occur at all because the pitch of the light absorption parts 51 of the CRF 50 is equal to the pitch between the scanning electrode 20 and the discharge sustaining electrode 10. That is, the light absorption parts 51 of the CRF 50 are over the scanning electrode 20 and the discharge sustaining electrode 10, exerting no influence on transmittance.

On the other hand, since the light absorption parts 51 of the CRF 50 are formed only sparsely, the effect of refining contrast is smaller than that in the first embodiment. However, if the effect of refining contrast is not perfect but somewhat satisfactory, the present invention can be used for specific applications by keeping a balance with the effect of reducing moiré.

In the present embodiment, since the pitch of the light absorption parts 51 of the CRF 50 is large, the size of individual light absorption parts 51 can be increased. For example, in FIG. 12, the height H2 of the light absorption parts 51 can be easily set to about 240 μm, twice that in the first embodiment. Moreover, the size of the width B at the bottom of the light absorption parts 51 can be enlarged within the width of the scanning electrode 20 or the like.

Also in the present embodiment, the light absorption parts 51 of the CRF 50 must be made to match the scanning electrode 20 and the discharge sustaining electrode 10 in the front substrate 1. This is enabled by sticking the CRF 50 directly to the front substrate 1 of the plasma display panel 100.

The present embodiment assumes that the pitch of the light absorption parts 51 of the CRF 50 is equal to the pitch between the scanning electrode 20 and the discharge sustaining electrode 10 of the plasma display panel 100. However, the present embodiment, without being limited to this, produces an effect even when the pitch of the light absorption parts 51 of the CRF 50 is an integral submultiple (e.g., one half or one third) of the pitch between the scanning electrode 20 and the discharge sustaining electrode 10 of the plasma display panel 100.

In such a case, the effect of refining contrast by the CRF 50 is greatly increased in comparison with the case where the pitch of the light absorption parts 51 of the CRF 50 is equal to the pitch between the scanning electrode 20 and the discharge sustaining electrode 10 of the plasma display panel 100, as described previously. On the other hand, although moiré occurs a little, its strength can be suppressed to a small degree.

In this way, even when the pitch of the light absorption parts 51 of the CRF 50 is an integral submultiple (e.g., one half or one third) of the pitch between the scanning electrode 20 and the discharge sustaining electrode 10 of the plasma display panel 100, moiré can be controlled by sticking the CRF 50 directly to the plasma display 100.

The foregoing description assumes that the scanning electrodes 20 and the discharge sustaining electrodes 10 are disposed at equal spaces apart mutually. For example, in FIG. 2, the space between the scanning electrode Y1 and the discharge sustaining electrode X1, the space between the discharge sustaining electrode X1 and the scanning electrode Y2, and the space between the scanning electrode Y2 and the discharge sustaining electrode X2 each are equal.

The foregoing description assumes that the pitch of the light absorption parts 51 of the CRF 50 is an integral submultiple of the pitch between the scanning electrode 20 and the discharge sustaining electrode 10 of the plasma display panel 100. Although this relationship is considered best for moiré control, in some cases, it may be impossible that this relationship is provided between the pitches. Even in such cases, by sticking the CRF 50 directly to the plasma display panel, the positional relationship between the CRF 50 and the plasma display panel 100 can be correctly controlled to maintain moir6 below a certain level.

### Third Embodiment

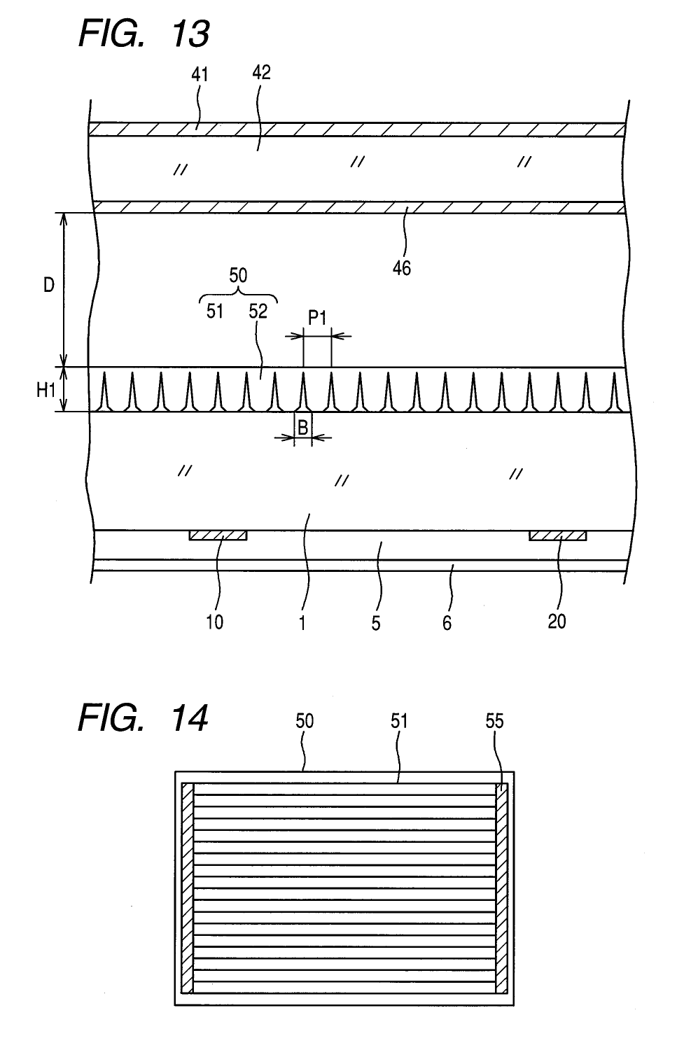

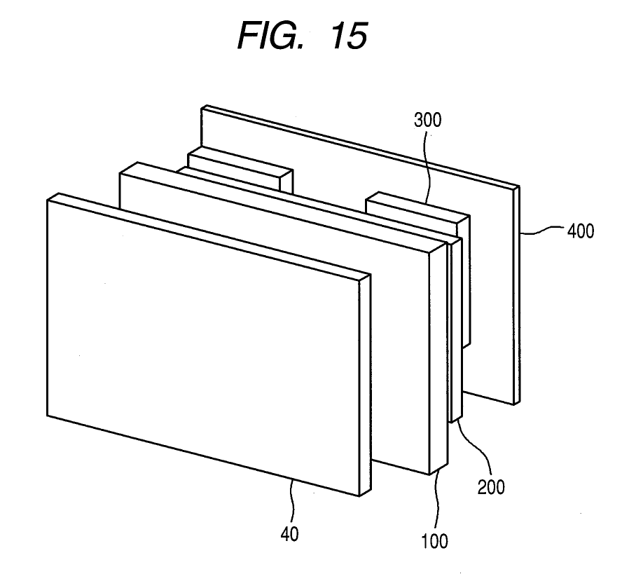

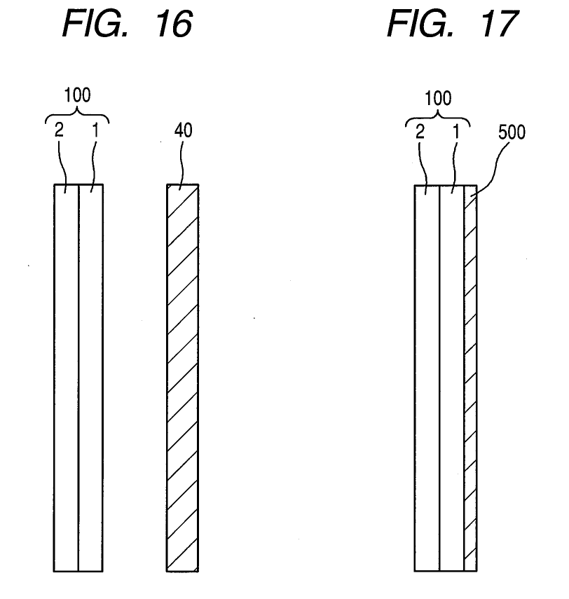

FIG. 13 is a sectional view showing a third embodiment of the present invention. FIG. 13 is a sectional view showing that the front panel 40 is disposed at a distance D from the front substrate 1 of the plasma display panel 100. In FIG. 13, the distance between the plasma display panel 100 and the front panel 40 is 5 to 10 mm.

In FIG. 13, the shape of the CRF 50 stuck directly to the plasma display panel 100 is the same as that in the first embodiment shown in FIG. 6. The present embodiment is different from the first embodiment in that the light absorption parts 51 of the CRF 50 are made of a conductive material. Although the light absorption parts 51 are disposed apart mutually in FIG. 13, by forming, for example, CRF bus electrodes 55 at each side of the CRF 50 as shown in FIG. 14, a reference potential such as ground potential can be afforded to all the light absorption parts 51 of the CRF 50.

FIG. 14 is a plan view showing the CRF 50 in the present embodiment. In FIG. 14, the light absorption parts 51 extend laterally, and are arrayed longitudinally. Although the light absorption parts 51 have the very small longitudinal pitch of about 65 μm, FIG. 14 is schematically shown to ease understanding. The CRF bus electrodes 55 are formed at each side of the light absorption parts 51 and connect the light absorption parts 51 made of a conductive material such as metal. Therefore, the CRF 50 has the same potential on the whole surface.

Other configurations on the part of the plasma display panel 100 in FIG. 13 are the same as those described in FIG. 6. Like FIG. 10, the antireflection film 41 serving as a color tone film as well is stuck to the filter glass 42 at the side opposite to the plasma display panel 100.

In FIG. 13, although the NIR film 46 is stuck to the plasma display panel 100 of the front panel 40, the mesh film 45 for preventing electromagnetic radiation is not disposed. This is because, in the present embodiment, electromagnetic radiation is prevented by the conductive light absorption parts 51 formed in the CRF 50.

As described above, in the present embodiment, although only the CRF 50 is stuck to the plasma display panel 100, since the CRF 50 is constructed to have the effect of preventing electromagnetic radiation, the conductive film for preventing electromagnetic radiation can be omitted from the front panel 40, contributing to reduction in costs of the front panel 40.

Also in the present embodiment, like the first embodiment and the like, by sticking the CRF 50 to the plasma display panel 100, the influence of moiré can be reduced with improvement in contrast.

In the embodiments described above, examples have been described that stick only the CRF 50 to the plasma display panel 100 and other sheets and films to the front panel 40. However, the CRF 50 and the mesh film 45 may be stuck to the plasma display panel 100 and other sheets and films may be stuck to the front panel 40. As described above, since the mesh 451 of the mesh film 45 is made of a material that does not transmit light, a light and black pattern of a predetermined cycle is formed in the mesh film 45. As a result, the mesh film 45 causes optical interference with the plasma display panel 100 (its scanning electrodes and discharge sustaining electrodes), causing moiré to occur. However, if the mesh film 45 is stuck to the plasma display panel 100 together with the CRF 50, since mesh film 45 can be brought near to the plasma display panel 100, optical interference between the mesh film 45 and the individual electrodes of the plasma display panel 100 is reduced, so that moiré can be made inconspicuous. At this time, since optical interference with various electrodes of the plasma display panel 100 is greater in the CRF 50, preferably, the CRF 50 should be brought nearer to the plasma display panel 100 by stacking the CRF 50 and the mesh film in this order from the surface of the CRF 50 to the front panel 40. Taking the ease of sticking to the plasma display panel 100 and an increase in the absorption of electromagnetic waves into account, the order of the stacking may be reversed.

What is claimed is:

1. A plasma display device comprising:
a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction; and
a front panel disposed at a specific distance from the front substrate of the plasma display panel,
wherein, on the front substrate of the plasma display panel, a black stripe film having light absorption parts that extend in the first direction and are arrayed in the second direction is disposed, and
wherein, on the front panel, an antireflection film, a color tone adjustment film, an electromagnetic radiation preventing film, and a near-infrared radiation preventing film are formed.

2. The plasma display device according to claim 1,
wherein the light absorption parts of the black stripe film are larger in width on the part of the front substrate and smaller in width on the part of the front panel.

3. A plasma display device comprising:
a plasma display panel having a front substrate on which scanning electrodes extend in a first direction, and are arrayed in a second direction, discharge sustaining electrodes extend in the first direction, and are arrayed in the second direction, and the scanning electrodes and the discharge sustaining electrodes are arrayed in the second direction at an equal distance W, and a rear substrate on which address electrodes extend in the second direction, and are arrayed in the first direction; and
a front panel disposed at a specific distance from the front substrate of the plasma display panel,
wherein, on the front substrate of the plasma display panel, a black stripe film having light absorption parts that extend in the first direction and are arrayed in the second direction with a pitch P is disposed,
wherein a relation of W/P=N (N is an integer) exists between the distance W between the scanning electrodes and the discharge electrodes, and the pitch P of the light absorption parts of the black stripe film, and
wherein, on the front panel, an antireflection film, a color tone adjustment film, and an electromagnetic radiation preventing film, and a near-infrared radiation preventing film are formed.

4. The plasma display device according to claim 3,
wherein the light absorption parts of the black stripe film are larger in width on the part of the front substrate and smaller in width on the part of the front panel.

5. The plasma display device according to claim 3,
wherein the light absorption parts of the black stripe film are formed in positions corresponding to the scanning electrodes and the discharge sustaining electrodes formed on the front substrate.

6. The plasma display device according to claim 3,
wherein the N is 1.

7. A plasma display device comprising:
a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction; and
a front panel disposed at a specific distance from the front substrate of the plasma display panel,
wherein, on the front substrate of the plasma display panel, a black stripe film having light absorption parts that extend in the first direction and are arrayed in the second direction is disposed, and the light absorption parts have conductivity, and are electrically conducted with each other, and
wherein, on the front panel, an antireflection film, a color tone adjustment film, and a near-infrared radiation preventing film are formed.

8. A plasma display device comprising:
a plasma display panel having a front substrate on which scanning electrodes extend in a first direction, and are arrayed in a second direction, and discharge sustaining electrodes extend in the first direction, and are arrayed in the second direction with a specific distance from the scanning electrodes, and a rear substrate on which address electrodes extend in the second direction, and are arrayed in the first direction; and
a front panel disposed at a specific distance from the front substrate of the plasma display panel,
wherein, on the front substrate of the plasma display panel, a black stripe film having light absorption parts that extend in the first direction and are arrayed in the second direction, and an electromagnetic radiation preventing film are disposed, and
wherein, on the front panel, an antireflection film, a color tone adjustment film, and a near-infrared radiation preventing film are formed.
